(19) United States
(12) Patent Application Publication
(10) Pub. No.: US 2022/0281031 A1
(43) Pub. Date: Sep. 8, 2022

(54) WELDING GAS SHIELDING DEVICE, LASER FILLER WIRE WELDING SYSTEM AND WELDING METHOD

(71) Applicant: Nanchang Hangkong University, Nanchang City (CN)

(72) Inventors: Shanlin Wang, Nanchang City (CN); Yuanmin Zhang, Nanchang City (CN); Jijun Xin, Nanchang City (CN); Yuhua Chen, Nanchang City (CN); Jilin Xie, Nanchang City (CN); Naiwen Fang, Nanchang City (CN); Timing Zhang, Nanchang City (CN); Jinyang Hu, Nanchang City (CN); Yongde Huang, Nanchang City (CN)

(21) Appl. No.: 17/686,258

(22) Filed: Mar. 3, 2022

(30) Foreign Application Priority Data
Mar. 4, 2021 (CN) 202110238293.7

(51) Int. Cl. B23K 26/323; B23K 26/24; B23K 26/14; B23K 26/211; B23K 37/06

(52) U.S. Cl. CPC B23K 26/323; B23K 26/24; B23K 26/1464; B23K 26/211; B23K 37/06

(57) ABSTRACT

The present disclosure discloses a welding gas shielding device, a laser filler wire welding system and a welding method. The welding gas shielding device comprises an upper shielding gas dragging cover device and a back shielding gas device. The laser filler wire welding system comprises a welding gas shielding device, a height adjusting mechanism, a wire feeding system, a laser system, a numerical control console and the like. The welding gas shielding device for narrow gaps made of dissimilar materials is reasonable in structural design, gas shielding can be carried out on the upper area and the lower area of a welding area in the welding process of the narrow gaps made of dissimilar materials, the problem that laser narrow-gap welding gas shielding is insufficient and unstable is solved, the weld joint cooling speed can be adjusted and controlled, the shielding effect is enhanced, and the welding efficiency is improved.

### CROSS REFERENCE TO RELATED APPLICATION

This patent application claims the benefit and priority of Chinese Patent Application No. 202110238293.7, filed on Mar. 4, 2021, the disclosure of which is incorporated by reference herein in its entirety as part of the present application.

### TECHNICAL FIELD

The present disclosure relates to the technical field of laser filler wire welding, in particular to a welding gas shielding device and a laser filler wire welding system for narrow gaps made of dissimilar materials and a welding method.

### BACKGROUND

Magnet containers in China Fusion Engineering Experiment Reactor (CFETR) are mostly made of SUS316 series austenitic stainless steel, the magnet containers bear a large electromagnetic force effect under a magnetic field, the yield strength of an external structural material needs to meet the 1000 MPa level, and under the current condition, common austenitic stainless steel materials cannot meet the strength condition. The Inconel718 nickel-based high-temperature alloy has the characteristics of high strength, good creep resistance, excellent fatigue resistance and the like, and can be used as part of the material of the external component of the magnet coil of the magnet container. On the basis, the part, with large stress, of the magnet container can be made of Inconel718 high-temperature alloy with high strength, the other parts are made of SUS316 austenitic stainless steel, and therefore a device and a method for welding dissimilar materials of Inconel718 and SUS316 need to be provided.

Due to the fact that physical properties, chemical properties, chemical components and the like of the dissimilar material welding are remarkably different, the dissimilar material welding is difficult to weld compared with the same material in terms of weldability and operation technology. If traditional welding methods such as electric arc welding are adopted, joint deformation is easily caused, defects such as cracks, air holes and inclusions are easily generated in the weld joints, and the strength of the joints is low. The laser welding has the characteristics of high energy density, small heat input, high welding speed, small welding deformation and the like, and the problems of the traditional welding methods are overcome. Compared with laser self-melting welding, the laser filler wire welding greatly reduces the heat input amount, saves the welding cost, has the remarkable characteristics of weld metal component adjustment and metallurgy, and provides a solution for welding of dissimilar materials of SUS316 austenitic stainless steel and Inconel718 high-temperature alloy.

According to Inconel718 and SUS316 dissimilar material laser filler wire welding, especially narrow gap laser filler wire welding, double advantages of laser welding and narrow-gap welding are combined. However, in previous devices, devices for gas shielding of narrow-gap laser filler wire welding of thick plates made of different materials and effective cooling forming of weld metal are not mature enough. The existing technical patents at home and abroad are as follows: (1) a gas shielding device (with the patent publication number of CN106392319A) for thick plate ultra-narrow gap laser filler wire welding, wherein the problem that the shielding effect of a gas shielding welding device for thick plate ultra-narrow gap laser filler wire welding is unstable is solved by adopting a main shielding gas flow pipe and an auxiliary shielding gas flow pipe; (2) a thick plate narrow-gap laser welding method (with the patent publication number of CN104874919A), wherein welding flux is conveyed through a movable powder feeding pipe, and gas shielding is carried out by using a gas curtain protection cover with a plurality of air outlets in the horizontal direction; and (3) a laser filler wire welding wire feeding and all-around gas shielding composite mechanism (with the patent publication number of CN111014954A), wherein all-around gas shielding is carried out in the laser filler wire welding process through the combination of an outer cover body and an inner shell.

Through research on existing patents related to narrow-gap laser filler wire welding at home and abroad, most of the patents are free of sufficient gas shielding on the upper portion of a welding area, and shielding of metal vapor plume or plasma cloud to laser is difficult to effectively reduce; and in previous devices, an effective gas shielding device for the back surface of a connector is lacked. In addition, for thick plate narrow-gap laser filler wire welding, as a groove is deep and narrow, shielding gas is difficult to enter the bottom of the groove, a shielding gas nozzle adopted at present can protect the bottom of the groove with the thickness of about 20 mm, but a weldment is thicker, welding defects such as oxidation and gas holes occur to several layers of weld joints at the bottom due to insufficient gas shielding, and the deficiencies are not taken into account in previous devices. Meanwhile, the cooling protection of the weld joints is not taken into account in previous devices, and the formation of the weld joints is influenced.

Aiming at the defects in previous devices, the present disclosure urgently provides an effective welded joint gas shielding scheme capable of meeting the narrow-gap laser filler wire welding of dissimilar materials.

### SUMMARY

The present disclosure aims to provide a welding gas shielding device and a laser filler wire welding system for narrow gaps made of dissimilar materials and a welding method so as to solve the problems that existing austenitic stainless steel and high-temperature alloy dissimilar material narrow-gap laser filler wire welding gas shielding is unstable and insufficient, the weld joint cooling effect is poor, and good welded joints are difficult to form.

In order to achieve the purpose, the present disclosure provides the following scheme:

The present disclosure provides a welding gas shielding device for welding narrow gaps made of dissimilar materials, particularly suitable for welding between dissimilar materials of Inconel718 high-temperature alloy and SUS316 austenitic stainless steel, comprising:

an upper shielding gas dragging cover device, the upper shielding gas dragging cover device comprising a cover body, a main shielding gas connector, an auxiliary shielding gas connector and a side shielding gas connector, the cover body being arranged above a welded part, the main shielding gas connector being arranged on the cover body and used for blowing main shielding gas into a molten pool area of the welded part, the auxiliary shielding gas connector being arranged on the cover body and used for blowing auxiliary shielding gas into a weld joint area on the upper surface of the welded part, and the side shielding gas connector being arranged on the cover body and used for horizontally blowing side shielding gas out to the upper surface of the molten pool area; and

a back shielding gas device, the back shielding gas device comprising a pipe body arranged below the welded part, a back shielding gas connector being arranged at one end of the pipe body, a groove being formed in the upper surface of the pipe body and located in a weld joint area on the back surface of the welded part, the top end or the side waist of the groove being used for abutting against liquid metal in the molten pool so as to control the root reinforcement of the weld joint, and back shielding gas outlet holes being formed in the inner wall of the groove and used for blowing back shielding gas introduced from the back shielding gas connector to the back surface of the weld joint.

Optionally, a main shielding gas flow pipe is arranged on one side in the cover body, a gas inlet of the main shielding gas flow pipe is connected with the main shielding gas connector, and a gas outlet of the main shielding gas flow pipe is located above the molten pool area.

Optionally, the main shielding gas flow pipe is a universal joint pipe in threaded connection, and the universal joint pipe is used for adjusting the blowing direction of main shielding gas, namely adjusting the direction of the gas outlet of the main shielding gas flow pipe.

Optionally, the main shielding gas is obliquely blown into the molten pool area of the welded part, the auxiliary shielding gas is vertically blown into the weld joint area of the welded part, the gas flow of the side shielding gas is larger than that of the main shielding gas, and the gas flow of the main shielding gas is larger than that of the auxiliary shielding gas.

Optionally, an auxiliary shielding gas accommodating cavity is formed in the other side in the cover body, a gas inlet of the auxiliary shielding gas accommodating cavity is connected with the auxiliary shielding gas connector, and a plurality of auxiliary shielding gas flow holes are formed in the bottom end surface of the auxiliary shielding gas accommodating cavity; and at least one layer of gas flow calming sieve is arranged between the gas inlet of the auxiliary shielding gas accommodating cavity and the auxiliary shielding gas flow holes.

Optionally, a side shielding gas channel is horizontally arranged at the top in the cover body, a gas inlet of the side shielding gas channel is connected with the side shielding gas connector, a gas outlet of the side shielding gas channel penetrates through the side wall of the cover body, and the side shielding gas channel horizontally blows out the side shielding gas at a certain pressure.

Optionally, the pipe body is a square hollow copper pipe; and the back shielding gas outlet holes are distributed in at least one row in the groove bottom surface of the groove. The back shielding gas outlet holes are used for vertically blowing the back shielding gas to the back surface of the weld joint.

Optionally, the groove is a U-shaped groove; or the groove is a W-shaped groove, and the top surface of the middle bulge of the W-shaped groove is lower than the upper surface of the pipe body.

Meanwhile, the present disclosure provides a laser filler wire welding system for welding narrow gaps made of dissimilar materials, mainly comprising a numerical control console, a workbench, a laser, a laser welding head connected with the laser, wire feeding gun adjusters installed on one side of the laser welding head, a wire feeding gun installed below the wire feeding gun adjusters, a wire feeder connected with the wire feeding gun adjusters and a welding gas shielding device according to any one of claims 1-8, wherein the welding gas shielding device comprises the upper shielding gas dragging cover device and the back shielding gas device, the upper shielding gas dragging cover device is located above the workbench, the top of the upper shielding gas dragging cover device is connected to the other side of the laser welding head through a height adjusting rod, namely the upper shielding gas dragging cover device is located on the rear side of the welding direction, and the pipe body of the back shielding gas device is embedded in the upper surface of the workbench; and the laser, the wire feeder and/or the welding gas shielding device are/is electrically connected with the numerical control console.

Meanwhile, the present disclosure provides a laser filler wire welding method based on the laser filler wire welding system, namely, a narrow-gap groove structure is adopted between two welded parts made of dissimilar materials, and backing welding, filling welding and cover welding are sequentially carried out at the narrow-gap groove between the two welded parts made of dissimilar materials through a laser filler wire welding method for layer-by-layer welding; and during welding of each layer, a laser beam emitted by the laser welding head is inclined by 7° to 10° towards one side of the wire feeding gun relative to the surface normal of the welded part so as to carry out triangular sewing type scanning on a narrow-gap welding groove, and meanwhile, a heat source is applied to form a welding pool. In the laser filler wire welding process, the welding gas shielding device plays a shielding role in the welding process.

Compared with previous devices, the present disclosure has the following technical effects:

The welding gas shielding device for narrow gaps made of dissimilar materials provided by the present disclosure is reasonable in structural design, gas shielding can be carried out on the upper area and the lower area of a welding area in the welding process of the narrow gaps made of dissimilar materials, the problem that laser narrow-gap welding gas shielding is insufficient and unstable is solved, the weld joint cooling speed can be adjusted and controlled, the shielding effect for weld joints is enhanced, and welded joints which meet the welding mechanical properties and are good in surface forming can be obtained. Reference is provided for laser filler wire welding of dissimilar materials of similar austenitic stainless steel and high-temperature alloy, is particularly suitable for laser narrow-gap welding of dissimilar materials of SUS316 austenitic stainless steel and Inconel718 high-temperature alloy, and particularly all-around, stable and effective gas shielding for welding of thick plate materials is provided. The welding gas shielding device has the following advantages:

firstly, the upper shielding gas dragging cover device and the back shielding gas device are used in a matched mode, gas shielding and gas cooling can be carried out on the upper surfaces and the lower surfaces of a molten pool and a weld joint, and oxidation of the molten pool and the weld joint under the heat influence effect is effectively prevented;

secondly, shielding air flow has certain stiffness and good stability, air around the welding area can be exhausted, meanwhile, shielding of metal vapor plume or plasma cloud to laser can be effectively reduced through the shielding gas, and the welding quality is improved;

thirdly, the upper shielding gas dragging cover device utilizes three gas outlet directions of main shielding gas, auxiliary shielding gas and side shielding gas, the main shielding gas plays a role in inhibiting metal steam cloud and protecting the welding pool, the auxiliary shielding gas shields weld metal and improves the cooling and solidifying effects of the metal, and the side shielding gas can protect a focusing lens from being polluted, and gas shielding on the upper part of the surface of a connector which is not protected by the main shielding gas;

fourthly, the back shielding gas device is a hollow pipe body with a groove to carry out gas shielding on the back surface of the weld joint and molten pool, so that effective gas shielding can be formed, and the root reinforcement of the weld joint can be effectively controlled; and

fifthly, the upper surface and the lower surface are simultaneously subjected to gas cooling, so that the temperature gradient of the welding area can be effectively controlled, metal in the molten pool is uniformly spread during solidification, and welded joints with uniform and attractive appearance and meeting the mechanical properties are obtained.

In addition, the present disclosure provides a laser filler wire welding system and a welding method which are suitable for laser narrow-gap welding of dissimilar materials of SUS316 austenitic stainless steel and Inconel718 high-temperature alloy, and compared with the scheme that a single inclined gas shielding device is adopted for protecting the upper surface of the welding area in previous devices; according to the laser filler wire welding system and the welding method, through effective shielding of the novel welding gas shielding device, the laser narrow-gap welding requirements of dissimilar material thick plates of SUS316 austenitic stainless steel and Inconel718 high-temperature alloy can be met, and gas shielding is carried out on the upper area and the lower area of the welding area during laser filler wire welding, so that the problem that laser narrow-gap welding gas shielding is insufficient and unstable is solved, the welding quality is improved, and the practicability is high.

### BRIEF DESCRIPTION OF THE DRAWINGS

To more clearly illustrate the embodiment of the present disclosure or the technical scheme in previous devices, the following briefly introduces the attached figures to be used in the embodiment. Apparently, the attached figures in the following description show merely some embodiments of the present disclosure, and those skilled in the art may still derive other drawings from these attached figures without creative efforts.

FIG. 1 is an integral structural schematic diagram of a laser filler wire welding system in the present disclosure;

FIG. 2 is a structural schematic diagram of an upper shielding gas dragging cover device in a welding gas shielding device in the present disclosure;

FIG. 3 is a top view of an upper shielding gas dragging cover device in a welding gas shielding device in the present disclosure;

FIG. 4 is a section view of A-A surface of an upper shielding gas dragging cover device in FIG. 3;

FIG. 5 is a structural schematic diagram of a back shielding gas device in a welding gas shielding device in the present disclosure;

FIG. 6 is a local schematic diagram of a square hollow pipe body in a back shielding gas device in the present disclosure; and

FIG. 7 is a structural schematic diagram of a V-shaped narrow-gap groove structure with a truncated edge in the second embodiment of the present disclosure.

Reference signs in the attached figures: 100, welding gas shielding device; 1, laser; 2, laser welding head; 3, supporting rod; 4, fixed bolt; 5, height adjusting rod; 6, flange; 7, upper shielding gas dragging cover device; 8, back shielding gas device; 9, back shielding gas connector; 10, wire feeding gun adjuster; 11, wire feeding gun; 12, welding wire; 13, welded part; 14, working platform; 15, laser control cable; 16, numerical control console; 17, wire feeder control cable; 18, wire feeder; 19, shielding gas flow and movement control cable; 20, connecting rod; 21, side shielding gas connector; 21, auxiliary shielding gas connector; 23, main shielding gas connector; 24, Inconel718 high-temperature alloy welded part; 25, laser beam; 26, SUS316 stainless steel welded part; 27, weld joint and molten pool; 28, side shielding gas channel; 29, auxiliary shielding gas accommodating cavity; 30, gas flow calming sieve; 31, auxiliary shielding gas flow hole; 32, auxiliary shielding gas channel; 33, main shielding gas channel; 34, side shielding gas outlet; 35, main shielding gas pipe connecting connector; 36, baffle plate; 37, main shielding gas flow pipe; 38, main shielding gas outlet; 39, special clamp; 40, copper base plate; 41, square hollow copper pipe; 42, workbench; 43, back shielding gas channel; 44, back shielding gas outlet hole; and 45, groove.

### DETAILED DESCRIPTION

The following clearly and completely describes the technical scheme in the embodiments of the present disclosure with reference to the attached figures in the embodiments of the present disclosure. Apparently, the described embodiments are merely a part rather than all of the embodiments of the present disclosure. Based on the embodiment in the present disclosure, all other embodiments obtained by the ordinary technical staff in the art under the premise of without contributing creative labor belong to the scope protected by the present disclosure.

The present disclosure aims to provide a welding gas shielding device and a laser filler wire welding system for narrow gaps made of dissimilar materials and a welding method so as to solve the problems that existing austenitic stainless steel and high-temperature alloy dissimilar material narrow-gap laser filler wire welding gas shielding is unstable and insufficient, the weld joint cooling effect is poor, and good welded joints are difficult to form.

To make the foregoing objective, features and advantages of the present disclosure clearer and more comprehensible, the present disclosure is further described in detail below with reference to the attached figures and specific embodiments.

### Embodiment I

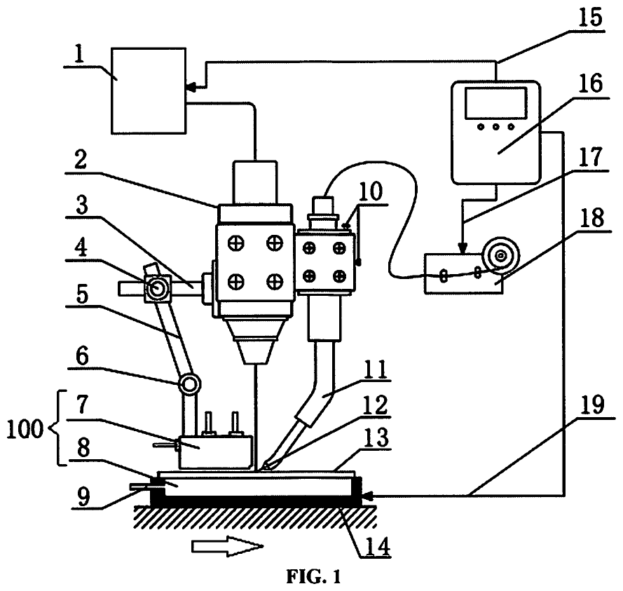

As shown in FIG. 1 to FIG. 6, the embodiment provides a welding gas shielding device 100 for welding narrow gaps made of dissimilar materials, particularly suitable for welding between dissimilar materials of Inconel718 high-temperature alloy and SUS316 austenitic stainless steel. The welding gas shielding device 100 for welding narrow gaps made of dissimilar materials comprises an upper shielding gas dragging cover device 7 and a back shielding gas device 8.

The upper shielding gas dragging cover device 7 is mainly composed of a cover body, a main shielding gas connector 23, an auxiliary shielding gas connector 22, a side shielding gas connector 21, a main shielding gas flow pipe 37, gas flow calming sieves 30, an auxiliary shielding gas accommodating cavity 29, a side shielding gas channel 28 and the like, wherein the main shielding gas is obliquely blown into a molten pool area through the main shielding gas connector 23 and the main shielding gas flow pipe 37 and used for reducing the shielding of plasma cloud formed by metal vapor ionization on laser, improving the effective utilization rate of the laser and protecting a welding pool, and the flow of the main shielding gas flow is preferably 25-35 L/min; auxiliary shielding gas flow is vertically blown into a weld joint area through the auxiliary shielding gas connector 22, the auxiliary shielding gas accommodating cavity 29, the gas flow calming sieves 30 and auxiliary shielding gas flow holes 31, the auxiliary shielding gas connector 22 is formed in the top end surface of the auxiliary shielding gas accommodating cavity 29, a plurality of auxiliary shielding gas flow holes 31 are formed in the bottom end surface of the auxiliary shielding gas accommodating cavity 29, an auxiliary shielding gas channel 32 is formed between the auxiliary shielding gas connector 22 and the auxiliary shielding gas flow holes 31, two layers of gas flow calming sieves 30 are preferably arranged in the auxiliary shielding gas channel 32, so that gas turbulence can be effectively reduced, the deflection of shielding gas flow is improved, overheated weld metal is protected by gas, the shielding effect on a welding metal cooling section is improved, and the flow of auxiliary shielding gas flow is preferably 20-30 L/min; side shielding gas flow is horizontally blown out to the upper surface of the molten pool through the side shielding gas connector 21, the side shielding gas channel 28 and a side shielding gas outlet 34 at a certain pressure, the purpose of protecting the focusing lens from being polluted by metal vapor and being sputtered by liquid molten drops is achieved, and the flow of the side shielding gas flow is preferably 30-40 L/min.

The back shielding gas device 8 mainly comprises a back shielding gas connector 9 and a pipe body embedded in a working platform 14, a groove 45 is formed in the upper surface of the pipe body, back shielding gas flows into the pipe through the back shielding gas connector 9 and then is uniformly sprayed out along the back face of a weld joint through back shielding gas outlet holes 44 formed in the groove 45, and the flow of the back shielding gas flow is preferably 25-35 L/min. The back shielding gas can avoid direct contact between the back face of the weld joint and air and prevent overheating oxidation of the back weld joint and molten pool. In addition, shielding gas is introduced into the upper surface and the lower surface of the weld joint, weld joint metal can be uniformly cooled and formed, and perfect welded joints are formed.

In the embodiment, the main shielding gas flow pipe 37 is a universal joint pipe in threaded connection, so that the direction of a gas blowing port (namely a gas outlet) of the main shielding gas flow pipe 37 can be adjusted, and the main shielding gas is ensured to be blown into the bottom of the molten pool. Wherein, a main shielding gas channel 33 is formed in the universal joint pipe, the top end of the universal joint pipe is in butt joint with the main shielding gas connector 23 through a main shielding gas pipe connecting connector 35, and a main shielding gas outlet 38 is formed in the bottom end of the universal joint pipe. The main shielding gas flow pipe 37 also can use other bendable and adjustable elbow mechanisms other than universal joint structures.

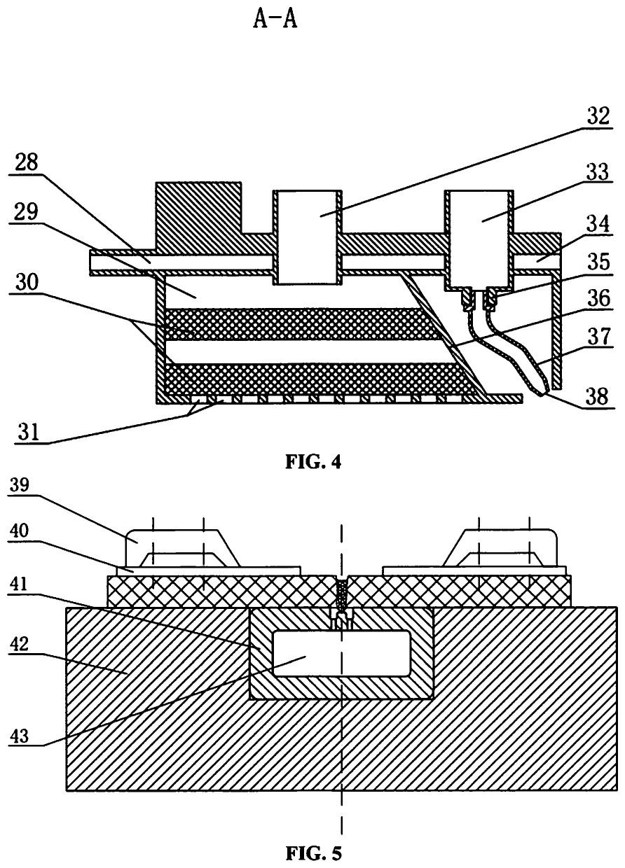

In the embodiment, as shown in FIG. 3 and FIG. 4, the main shielding gas flow pipe 37 is arranged on one side in the cover body, the auxiliary shielding gas accommodating cavity 29 is arranged on the other side in the cover body, and the main shielding gas flow pipe 37 and the auxiliary shielding gas accommodating cavity 29 are separated by a baffle plate 36. The side shielding gas channel 28 is horizontally arranged at the top of the cover body and sequentially penetrates through the two sides of the cover body from left to right. The auxiliary shielding gas connector 22 and the main shielding gas connector 23 are arranged on the top end surface of the cover body side by side and connected with the auxiliary shielding gas accommodating cavity 29 and the main shielding gas flow pipe 37 below the auxiliary shielding gas connector 22 and the main shielding gas connector 23 respectively.

In the embodiment, the side shielding gas flow in the upper shielding gas dragging cover device 7 is larger than the main shielding gas flow, and the main shielding gas flow is larger than the auxiliary shielding gas flow.

In the embodiment, the main shielding gas is preferably obliquely blown into a welding area of the welded part 13, the auxiliary shielding gas is vertically blown into the welding area of the welded part 13, and the side shielding gas is horizontally blown into the welding area of the welded part 13.

In the embodiment, the auxiliary shielding gas flow holes 31 in the upper shielding gas dragging cover device 7 are preferably uniformly distributed in two to four rows.

In the embodiment, the blowing surface at the bottom end of the upper shielding gas dragging cover device 7 is parallel to the upper surface of the welded part 13, and the distance is preferably 5-15 mm.

In the embodiment, the pipe body in the back shielding gas device 8 is preferably a square hollow copper pipe 41, and a hole is formed in one side of the square hollow copper pipe 41 to form the back shielding gas connector 9; and a back shielding gas channel 43 is formed in the square hollow copper pipe 41. A plurality of back shielding gas outlet holes 44 are formed in the bottom surface of the groove 45 and are preferably uniformly distributed in two rows.

In the embodiment, the back shielding gas in the back shielding gas device 8 is blown to the surface of the weld joint through the back shielding gas outlet holes 44 vertical to the back surface of the weld joint.

In the embodiment, the groove 45 in the back shielding gas device 8 can be a W-shaped or U-shaped groove, the W-shaped or U-shaped groove design is adopted, the top end or the side waist of the groove abuts against liquid metal in the molten pool, and root reinforcement formed by rapid cooling of the liquid metal can be effectively controlled.

According to the embodiment, the W-shaped groove design is preferred, and the back shielding gas outlet holes 44 are uniformly formed in the two side waists of the W-shaped groove. The middle convex part of the W-shaped groove is slightly lower than the upper surface of the square hollow copper pipe 41.

According to the embodiment, the welding gas shielding device 100 can be used for laser narrow-gap welding of dissimilar materials of SUS316 stainless steel and Inconel718 high-temperature alloy, and particularly all-around, stable and effective gas shielding for welding of thick plate materials is provided. Beneficial effects are as follows:

firstly, through combination of the upper shielding gas dragging cover device and the back shielding gas device, gas shielding and gas cooling effects are achieved on the upper surface and the lower surface of the molten pool and the weld joint;

secondly, the upper shielding gas dragging cover device utilizes three gas outlet directions of main shielding gas, auxiliary shielding gas and side shielding gas, the main shielding gas plays a role in inhibiting metal steam cloud and protecting the welding pool, the auxiliary shielding gas shields weld metal and improves the cooling and solidifying effects of the metal, and the side shielding gas can protect a focusing lens from being polluted, and gas shielding on the upper part of the surface of a connector which is not protected by the main shielding gas;

thirdly, the back shielding gas device is a hollow pipe body with a W-shaped groove to carry out gas shielding on the back surface of the weld joint and molten pool, so that effective gas shielding can be formed, and the root reinforcement can be effectively controlled; and

fourthly, the upper surface and the lower surface are simultaneously subjected to gas cooling, so that the temperature gradient of the welding area can be effectively controlled, and perfectly formed joints are obtained.

In the embodiment, the main shielding gas, the auxiliary shielding gas and the side shielding gas are sprayed at a certain pressure, for example, through an air pump structure and the like. The main shielding gas, the auxiliary shielding gas and the side shielding gas all adopt shielding gas sources commonly used in existing laser welding, so that the gas shielding effect of the embodiment can be achieved, and specific details are not needed.

### Embodiment II

As shown in FIG. 1, the embodiment provides a laser filler wire welding system. The laser filler wire welding system comprises an upper shielding gas dragging cover device 7, a flange 6, a height adjusting mechanism, a back shielding gas device 8, a wire feeding system, a laser system, a numerical control console 16, a control cable, a welded part 13 and the like, and the upper shielding gas dragging cover device 7 and the back shielding gas device 8 are both of structures described in the first embodiment. Wherein, the laser system comprises a laser 1 and a laser welding head 2 electrically connected with the laser 1, and the laser welding head 2 is used for emitting a laser beam 25; the height adjusting mechanism is composed of a supporting rod 3, a fixed bolt 4 and a height adjusting rod 5, a connecting rod 20 is arranged at the top end of the upper shielding gas dragging cover device 7 and connected to the height adjusting rod 5 through a flange 6, the height adjusting rod 5 is hinged to one end of the supporting rod 3 through the fixed bolt 4, the other end of the supporting rod 3 is fixed to one side of the laser welding head 2, the fixed bolt 4 is unscrewed, the height adjusting rod 5 can be rotated and finely adjusted to drive the upper shielding gas dragging cover device 7 to move, the height adjusting rod 5 is fixed by screwing the fixed bolt 4 after the upper shielding gas dragging cover device 7 is adjusted to the required height, the purpose that the upper shielding gas dragging cover device 7 is suitable for welded parts 13 with different thicknesses is achieved, and the height adjusting range of the upper shielding gas dragging cover device 7 is preferably 0-120 mm, so that the distance between the bottom surface of the upper shielding gas dragging cover device 7 and the upper surface of the welded part 13 is kept at 4-8 mm. The wire feeding system is mainly composed of a wire feeding gun 11, a welding wire 12, wire feeding gun adjusters 10, a wire feeder 18 and a wire feeder control cable 17, the numerical control console 16 transmits a wire feeding speed control signal of the wire feeder 18 through the wire feeder control cable 17, and in the whole laser filler wire welding process of dissimilar materials, the wire feeding speed is preferably 120-600 cm/min; and in addition, the position of the wire feeding gun 11 can be finely adjusted through the wire feeding gun adjusters 10, and the wire feeding angle range is preferably 45°+/−2°. The numerical control console 16 also controls the parameters and welding speed of the laser 1 through the laser control cable 15, and controls the shielding gas flow in the welding gas shielding device 100 through a shielding gas flow and movement control cable 19 so as to adapt to various parameter ranges of welded parts 13 with different thicknesses in the whole laser filler wire welding process of the dissimilar materials; the laser power is preferably 3.0-9.0 kW, the positive defocusing amount is preferably 4.0-50.0 mm, the flow of main shielding gas is preferably 25-35 L/min, the flow of auxiliary shielding gas is preferably 20-30 L/min, the flow of side shielding gas is preferably 30-40 L/min, the flow of back shielding gas is preferably 25-35 L/min, and the welding speed is preferably 80-200 cm/min; and the direction indicated by the arrow at the lower end of FIG. 1 is the relative movement direction of the laser beam 25.

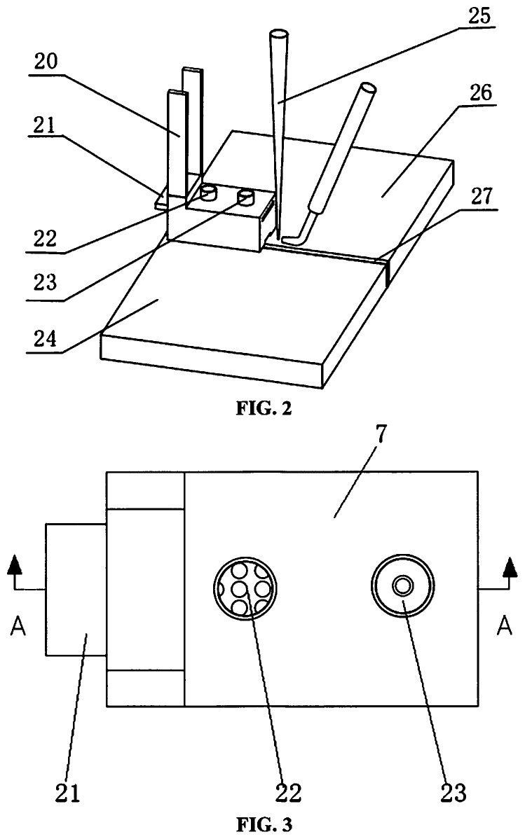

In the embodiment, the upper shielding gas dragging cover device 7 is as shown in FIG. 2 to FIG. 4, and is composed of main shielding gas blown into the molten pool, auxiliary shielding gas blown into the weld joint and side shielding gas horizontally blown into the upper surface of the molten pool. The main shielding gas is obliquely blown into the molten pool and used for reducing shielding of plasma cloud formed by ionization of metal vapor to laser, and the purpose of protecting the molten pool is achieved. The universal joint pipe is preferably adopted for conveying the main shielding gas, and it can be ensured that the shielding gas is input to the bottom of the molten pool, and the universal joint pipe is connected through an internal thread of the main shielding gas pipe connecting connector 35. The auxiliary shielding gas is vertically blown into the weld joint and used for shielding overheated weld joint metal and improving the metal cooling and solidifying effect, the auxiliary shielding gas accommodating cavity 29 is separated from the main shielding gas part through the obliquely arranged baffle plate 36, the baffle plate 36 shortens the bearing distance between the main shielding gas and the auxiliary shielding gas, and the continuity of gas shielding is improved; gas flow calming sieves 30 in the closed auxiliary shielding gas accommodating cavity 29 can effectively reduce the gas turbulence and keep the deflection of shielding gas flow; and the auxiliary shielding gas flow holes 31 are composed of two to four rows of uniformly distributed air holes. According to the embodiment, three rows of air holes are preferably adopted for exhausting shielding gas. Side shielding gas is horizontally blown into the upper surface of the molten pool and used for protecting the focusing lens from being polluted by metal vapor and being sputtered by liquid molten drops, and the side shielding gas channel 28 is preferably flat, so that compressed air can form jet-shaped gas, and the range of blowing into the upper surface of the molten pool is enlarged.

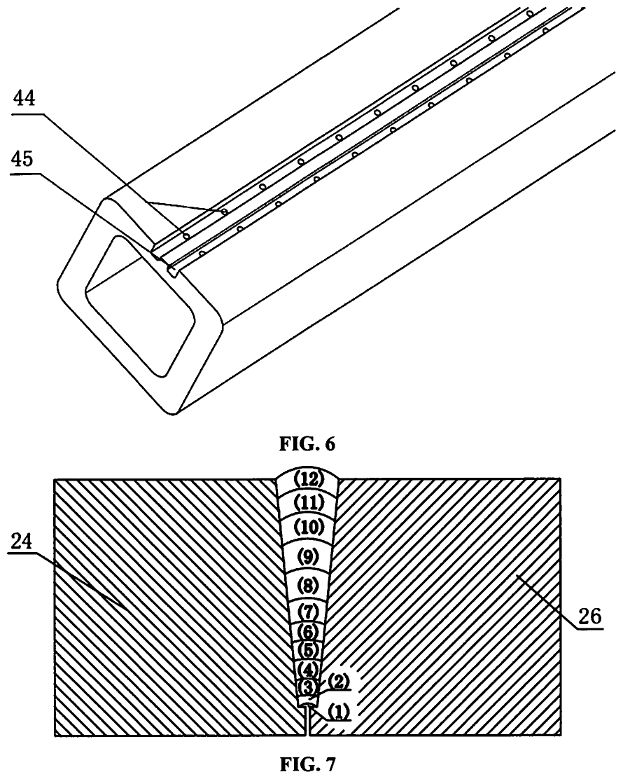

In the embodiment, the back shielding gas device 8 is as shown in FIG. 5 and FIG. 6, is used for gas shielding of the back weld joint and molten pool, and is mainly composed of special clamps 39, copper base plates 40, a back shielding gas connector 9 and a square hollow copper pipe 41. Wherein the special clamps 39 are used for effectively fixing the welded part 13 to prevent deformation of a workpiece after welding, and the copper base plates 40 are cushioned on the upper surface of the welded part 13 to play a role in heat dissipation; a hole is formed in one side of the square hollow copper pipe 41 and embedded in the middle of the workbench 42, and the workbench 42 is cushioned on the lower surface of the welded part 13 and has a certain heat dissipation effect; a W-shaped groove is formed in the upper surface of the square hollow copper pipe 41, a plurality of air outlet holes are uniformly formed in the two waists of the W-shaped groove to form back shielding gas outlet holes 44, shielding gas has certain pressure after being blown out of the air outlet holes and can also form supporting force on the back face of the weld joint together with a middle protruding part of the W-shaped groove, and the root reinforcement is effectively controlled. The workbench 42 is a working platform used for carrying the welded part 13 in the laser filler wire welding system, can be of the same component structure as the working platform 14 in the first embodiment, and can also be of a different component structure.

Meanwhile, the embodiment provides a laser filler wire welding method which is carried out by adopting the laser filler wire welding system and can meet the requirement for laser narrow-gap welding of thick plates made of dissimilar materials, and by taking SUS316 austenitic stainless steel and Inconel718 high-temperature alloy as an example, the laser filler wire welding method specifically comprises the following steps that a narrow-gap groove structure is adopted between the SUS316 austenitic stainless steel and the Inconel718 high-temperature alloy to be welded, under the conditions of proper laser beam parameters, welding wire feeding speed, shielding gas flow and welding speed, the dissimilar materials of SUS316 austenitic stainless steel and Inconel718 high-temperature alloy are subjected to layer-by-layer laser filler wire welding, and welded joints which meet the mechanical property requirement and are attractive in appearance are obtained.

In the embodiment, the laser filler wire welding method is suitable for laser layered filler wire welding of dissimilar materials of Inconel718 high-temperature alloy and SUS316 austenitic stainless steel with the thickness of 10-30 mm, and the range of the narrow-gap groove interval is preferably 3-6 mm.

In the embodiment, a V-shaped narrow-gap butt-joint groove type with a truncated edge is adopted between the Inconel718 high-temperature alloy and the SUS316 austenitic stainless steel, the truncated edge gap of the welding material is preferably 0-0.3 mm, the truncated edge thickness is preferably 3.0-5.0 mm, and the groove angle is preferably 3° on a single edge.

In the embodiment, in the laser filler wire welding method, the laser beam with a galvanometer scanning system is adopted, the laser beam is arranged to incline by 7° to 10° towards one side of the wire feeding gun 11 relative to the surface normal of the welded part, triangular sewing type scanning is carried out on a welding groove, and a heat source is applied to form a welding pool.

According to the embodiment, the laser filler wire welding process is adopted for sequentially carrying out multi-layer backing welding, filling welding and cover welding at the position of the narrow-gap groove structure, the weld joints are cleaned with acetone before welding of each layer, preferably, the backing welding laser power is 5.0-9.0 kW, the positive defocusing amount is 4.0-6.0 mm, the welding speed is 100-150 cm/min, the wire feeding speed is 120-200 cm/min, the main shielding gas flow is 25-35 L/min, the auxiliary shielding gas flow is 20-30 L/min, the side shielding gas flow is 30-40 L/min, the back shielding gas flow is 25-35 L/min, and the triangular scanning radius is 0.5-1.0 mm; preferably, the filling welding laser power is 4.0-7.0 kW, the positive defocusing amount is 20-35 mm, the welding speed is 140-200 cm/min, the wire feeding speed is 250-600 cm/min, the main shielding gas flow is 25-35 L/min, the auxiliary shielding gas flow is 20-30 L/min, the side shielding gas flow is 30-40 L/min, the back shielding gas flow is 25-35 L/min, and the triangular scanning radius is 1.0-1.5 mm; preferably, the cover welding laser power is 3.0-6.0 kW, the positive defocusing amount is 40-50 mm, the welding speed is 80-120 m/min, the wire feeding speed is 180-420 cm/min, the main shielding gas flow is 25-35 L/min, the auxiliary shielding gas flow is 20-30 L/min, the side shielding gas flow is 30-40 L/min, the back shielding gas flow is 25-35 L/min, and the triangular scanning radius is 0.5-1.0 mm.

According to the embodiment, when backing welding, filling welding and cover welding are sequentially carried out on the narrow-gap groove structure through the laser filler wire welding process, grinding is carried out through a grinding wheel before each layer is welded, interlayer repairing and weld reinforcement removing are carried out, and then the weld joints are cleaned with acetone. The selected welding wire is preferably ERNiFeCr-2, the diameter is 1.2 mm, and the wire feeding angle range is preferably 45°+/−2°.

The method suitable for narrow-gap laser filler wire welding of dissimilar materials of Inconel718 high temperature alloy and SUS316 austenitic stainless steel, provided by the embodiment, is specifically explained below and specifically comprises the following steps:

firstly, taking Inconel718 high-temperature alloy and SUS316 austenitic stainless steel plates which are respectively a Inconel718 high-temperature alloy welded part 24 and an SUS316 stainless steel welded part 26, preferably, the sizes of the two plates being 25 mm*200 mm*200 mm, grinding the surfaces of the parts to be welded before welding, removing oil stains and oxide layers on the surfaces of the parts to be welded, cleaning with acetone, and carrying out blow-drying;

secondly, as shown in FIG. 7, adopting a V-shaped narrow-groove type with a truncated edge for butt welding to achieve effective connection of dissimilar materials in a layer-by-layer filler wire welding mode; in the welding process, forming a weld joint and molten pool 27 between the Inconel718 high-temperature alloy welded part 24 and the SUS316 stainless steel welded part 26;

thirdly, enabling the welding wire 12 to be ERNiFeCr-2 with the diameter of 1.2 mm, carrying out certain chemical treatment, and drying and then putting the welding wire 12 into the wire feeder 18;

fourthly, fixing the Inconel718 high-temperature alloy welded part 24 and the SUS316 stainless steel welded part 26 on the workbench 42 through the special clamps 39;

fifthly, before welding, introducing main shielding gas, auxiliary shielding gas, side shielding gas and back shielding gas in advance for a period of time, so that the upper shielding gas dragging cover device 7 and the back shielding gas device 8 are filled with shielding gas, and continuous supply of the shielding gas is kept until welding is finished;

sixthly, setting thick plate welding parameters meeting the embodiment through the numerical control console 16, adopting the laser beam with a galvanometer scanning system, and enabling the laser beam to incline by 7° to 10° towards one side of the wire feeding gun 11 relative to the surface normal of the welded part, so that triangular sewing type scanning is carried out on the welding groove to apply a heat source to the molten pool, and due to thick plate narrow-gap welding, layer-by-layer backing welding, filling welding and cover welding need to be carried out sequentially;

seventhly, during layer-by-layer welding, carrying out grinding through the grinding wheel for interlayer repairing and weld reinforcement removing every time welding is completed, and then cleaning the weld joints with acetone;

eighthly, as shown in FIG. 7, carrying out backing welding for the first time, wherein the welding parameters are preferably as follows: the laser power is 7.0-8.0 kW, the positive defocusing amount is 4.0-5.0 mm, the welding speed is 100-150 cm/min, the wire feeding speed is 150-180 cm/min, the main shielding gas flow is 30-35 L/min, the auxiliary shielding gas flow is 25-30 L/min, the side shielding gas flow is 35-40 L/min, the back shielding gas flow is 30-35 L/min, and the triangular scanning radius is 0.7-0.8 mm;

ninthly, as shown in FIG. 7, carrying out filling welding for the second time to the eleventh time, and enabling the filler wire thickness in each layer to be smaller than 3 mm, wherein the filling welding parameters are preferably as follows: the filling laser power is 4.0-5.0 kW, the positive defocusing amount is 28-30 mm, the welding speed is 150-180 m/min, the wire feeding speed is 150-450 cm/min, the main shielding gas flow is 30-35 L/min, the auxiliary shielding gas flow is 25-30 L/min, the side shielding gas flow is 35-40 L/min, the back shielding gas flow is 30-35 L/min, and the triangular scanning radius is 1.0-1.2 mm;

tenthly, as shown in FIG. 7, carrying out cover welding for the last time, wherein the welding parameters are preferably as follows: the laser power is 7.0-4.5 kW, the positive defocusing amount is 43-45 mm, the welding speed is 70-100 cm/min, the wire feeding speed is 250-350 cm/min, the main shielding gas flow is 30-35 L/min, the auxiliary shielding gas flow is 25-30 L/min, the side shielding gas flow is 35-40 L/min, the back shielding gas flow is 30-35 L/min, and the triangular scanning radius is 1.6-1.8 mm; and

eleventhly, after welding is finished, cooling the weld joint of the welded part 13 to room temperature and taking out the welded part 13; and carrying out metallographic observation on the end surface of the weld joint, and detecting whether defects exist in the welding connector.

The dimensions and thicknesses of each of the components shown in the figures of the present embodiments are shown arbitrarily and are not limited to the dimensions and thicknesses of each of the components. The thickness of components has been appropriately exaggerated somewhere in the attached figures for clarity of the illustration.

It needs to be noted that for those skilled in the art, obviously the present disclosure is not limited to the details of the exemplary embodiment, and the present disclosure can be achieved in other specific forms without departing from the spirit or essential characteristics of the present disclosure. Therefore, for every point, the embodiments should be regarded as exemplary embodiments and are unrestrictive, the scope of the present disclosure is restricted by the claims appended hereto, therefore, all changes, including the meanings and scopes of equivalent elements, of the claims are aimed to be included in the present disclosure, and any mark of attached figures in the claims should not be regarded as limitation to the involved claims.

Specific examples are used for illustration of the principles and implementation methods of the present disclosure. The description of the above-mentioned embodiments is used to help illustrate the method and its core principles of the present disclosure. In addition, those skilled in the art can make various modifications in terms of specific embodiments and scope of application in accordance with the teachings of the present disclosure. In conclusion, the content of this specification shall not be construed as a limitation to the present disclosure.

What is claimed is:

1. A welding gas shielding device for welding narrow gaps made of dissimilar materials, comprising:
an upper shielding gas dragging cover device, the upper shielding gas dragging cover device comprising a cover body, a main shielding gas connector, an auxiliary shielding gas connector and a side shielding gas connector, the cover body being arranged above a welded part, the main shielding gas connector being arranged on the cover body and used for blowing main shielding gas into a molten pool area of the welded part, the auxiliary shielding gas connector being arranged on the cover body and used for blowing auxiliary shielding gas into a weld joint area on the upper surface of the welded part, and the side shielding gas connector being arranged on the cover body and used for horizontally blowing side shielding gas out to the upper surface of the molten pool area; and
a back shielding gas device, the back shielding gas device comprising a pipe body arranged below the welded part, a back shielding gas connector being arranged at one end of the pipe body, a groove being formed in the upper surface of the pipe body and located in a weld joint area on the back surface of the welded part, the top end or the side waist of the groove being used for abutting against liquid metal in the molten pool so as to control the root reinforcement of the weld joint, and back shielding gas outlet holes being formed in the inner wall of the groove and used for blowing back shielding gas introduced from the back shielding gas connector to the back surface of the weld joint.

2. The welding gas shielding device according to claim 1, wherein a main shielding gas flow pipe is arranged on one side in the cover body, a gas inlet of the main shielding gas flow pipe is connected with the main shielding gas connector, and a gas outlet of the main shielding gas flow pipe is located above the molten pool area.

3. The welding gas shielding device according to claim 2, wherein the main shielding gas flow pipe is a universal joint pipe in threaded connection, and the universal joint pipe is used for adjusting the blowing direction of main shielding gas.

4. The welding gas shielding device according to claim 1, wherein the main shielding gas is obliquely blown into the molten pool area of the welded part, the auxiliary shielding gas is vertically blown into the weld joint area of the welded part, the gas flow of the side shielding gas is larger than that of the main shielding gas, and the gas flow of the main shielding gas is larger than that of the auxiliary shielding gas.

5. The welding gas shielding device according to claim 2, wherein an auxiliary shielding gas accommodating cavity is formed in the other side in the cover body, a gas inlet of the auxiliary shielding gas accommodating cavity is connected with the auxiliary shielding gas connector, and a plurality of auxiliary shielding gas flow holes are formed in the bottom end surface of the auxiliary shielding gas accommodating cavity; and at least one layer of gas flow calming sieve is arranged between the gas inlet of the auxiliary shielding gas accommodating cavity and the auxiliary shielding gas flow holes.

6. The welding gas shielding device according to claim 2, wherein a side shielding gas channel is horizontally arranged at the top in the cover body, a gas inlet of the side shielding gas channel is connected with the side shielding gas connector, and a gas outlet of the side shielding gas channel penetrates through the side wall of the cover body.

7. The welding gas shielding device according to claim 1, wherein the pipe body is a square hollow copper pipe; the back shielding gas outlet holes are distributed in at least one row in the groove bottom surface of the groove; and the back shielding gas outlet holes are used for vertically blowing the back shielding gas to the back surface of the weld joint.

8. The welding gas shielding device according to claim 1, wherein the groove is a V-shaped groove; or the groove is a W-shaped groove, and the top surface of the middle bulge of the W-shaped groove is lower than the upper surface of the pipe body.

9. A laser filler wire welding system for welding narrow gaps made of dissimilar materials, comprising a numerical control console, a workbench, a laser, a laser welding head connected with the laser, wire feeding gun adjusters installed on one side of the laser welding head, a wire feeding gun installed below the wire feeding gun adjusters, a wire feeder connected with the wire feeding gun adjusters and a welding gas shielding device according to claim 1, wherein the welding gas shielding device comprises the upper shielding gas dragging cover device and the back shielding gas device, the upper shielding gas dragging cover device is located above the workbench, the top of the upper shielding gas dragging cover device is connected to the laser welding head through a height adjusting rod, and the pipe body of the back shielding gas device is embedded in the upper surface of the workbench; and the laser, the wire feeder and/or the welding gas shielding device are/is electrically connected with the numerical control console.

10. A laser filler wire welding method based on the laser filler wire welding system according to claim 9, wherein a narrow-gap groove structure is adopted between two welded parts made of dissimilar materials, and backing welding, filling welding and cover welding are sequentially carried out at the narrow-gap groove between the two welded parts made of dissimilar materials through a laser filler wire welding method; and during welding of each layer, a laser beam emitted by the laser welding head is inclined by 7° to 10° towards one side of the wire feeding gun relative to the surface normal of the welded part so as to carry out triangular sewing type scanning on the narrow-gap welding groove, and meanwhile, a heat source is applied to form a welding pool.
